(19) United States
(12) Patent Application Publication
(10) Pub. No.: US 2024/0233031 A9
(43) Pub. Date: Jul. 11, 2024

(54) SYSTEMS AND METHODS FOR DETERMINING EMBEDDING VECTORS FOR PROCESSING MEDICAL CLAIMS

(71) Applicant: Optum, Inc., Minnetonka, MN (US)

(72) Inventors: Rama Krishna SINGH, Greater Noida (IN); Ravi PANDE, Gautam Budh Nagar (IN); Priyank JAIN, Noida (IN)

(73) Assignee: Optum, Inc., Minnetonka, MN (US)

(21) Appl. No.: 18/048,515

(22) Filed: Oct. 21, 2022

(51) Int. Cl. G06Q 40/08; G06Q 50/22

(52) U.S. Cl. CPC G06Q 40/08; G06Q 50/22

(57) ABSTRACT

Systems and methods are disclosed for processing medical claims to determine vector embeddings for predictive analytics and fraud detection. The method includes receiving claim data for a medical claim, the claim data comprising a plurality of medical codes. A plurality of embedding vectors is determined based on the plurality of medical codes, each embedding vector determined based on a corresponding medical code. A multi-layered matrix is determined based on the plurality of embedding vectors determined for the plurality of medical codes, wherein the multi-layered matrix is representative of the medical claim. One or more actions such as predictive analytics and fraud detection are performed based on the multi-layered matrix.

### TECHNICAL FIELD

Various embodiments of the present disclosure relate generally to systems and methods for processing medical claims, and more particularly to, systems, computer-implemented methods, and non-transitory computer readable mediums for determining embedding vectors for processing one or more medical claims.

### BACKGROUND

Medical claims include data such as diagnosis codes, procedure codes along with information about the place of service/doctor/institution/time and amounts billed and charged. Some uses of the claim data may include processing this information to approve or deny medical claims for payments, to detect medical claim fraud, etc. Most of the use cases rely on top diagnosis and procedure codes from the claim information, and while that might be able to explain some of the variability of the target variable, it is better to have the complete information captured in the claim in terms of all of the diagnoses and procedures recorded. Therefore, a need exists for a system and method for more comprehensive representation of the entire claim.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

According to certain aspects of the disclosure, computer-implemented methods, systems, and non-transitory computer readable mediums are disclosed for processing medical claims to determine embedding vectors for predictive analytics and fraud detection.

In one embodiment, a computer-implemented method for generating machine-understandable representations of medical claims is disclosed. The method includes: receiving claim data for a medical claim, the claim data comprising a plurality of medical codes; determining a plurality of embedding vectors based on the plurality of medical codes, each embedding vector determined based on a corresponding medical code; determining a multi-layered matrix based on the plurality of embedding vectors determined for the plurality of medical codes, wherein the multi-layered matrix is representative of the medical claim; and performing one or more actions based on the multi-layered matrix.

In accordance with another embodiment, a system for generating machine-understandable representations of medical claims is disclosed. The system includes: a memory having processor-readable instructions stored therein; and a processor configured to access the memory and execute the processor-readable instructions to perform operations including: receiving claim data for a medical claim, the claim data comprising a plurality of medical codes; determining a plurality of embedding vectors based on the plurality of medical codes, each embedding vector determined based on a corresponding medical code; determining a multi-layered matrix based on the plurality of embedding vectors determined for the plurality of medical codes, wherein the multi-layered matrix is representative of the medical claim; and performing one or more actions based on the multi-layered matrix.

In accordance with a further embodiment, a non-transitory computer-readable medium storing a set of instructions that, when executed by a processor, perform operations for generating machine-understandable representations of medical claims is disclosed. The operations include: receiving claim data for a medical claim, the claim data comprising a plurality of medical codes; determining a plurality of embedding vectors based on the plurality of medical codes, each embedding vector determined based on a corresponding medical code; determining a multi-layered matrix based on the plurality of embedding vectors determined for the plurality of medical codes, wherein the multi-layered matrix is representative of the medical claim; and performing one or more actions based on the multi-layered matrix.

It may be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIG. 1 depicts a block diagram of an exemplary system for processing medical claims to determine embedding vectors for predictive analytics and fraud detection, according to one or more embodiments.

FIG. 2 depicts a flowchart illustrating an exemplary method for processing medical claims for determining embedding vectors for predictive analytics and fraud detection, according to one or more embodiments.

FIGS. 3A and 3B are diagrams that depict an example of processing medical claims for determining embedding vectors, according to one or more embodiments.

FIG. 4 depicts an example of multi-layered matrix representations or 3D matrix representations, according to one or more embodiments.

FIG. 5 depicts an example of determining one or more multi-layered matrix representations or 3D matrix representations, according to one or more embodiments.

FIG. 6 illustrates an implementation of a computer system that may execute techniques presented herein.

FIG. 7 shows an example machine learning training flow chart.

### DETAILED DESCRIPTION

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description.

Various non-limiting embodiments of the present disclosure relate generally to providing recommendations. More particularly, various embodiments of the present disclosure relate to systems, computer-implemented methods, and non-transitory computer readable mediums for processing medical claims to determine embedding vectors for predictive analytics and fraud detection.

Embedding vectors enable machines to understand unstructured textual data, and are utilized in a vast range of applications including healthcare and life science. For example, embedding vectors are created for medical codes, such as international classification of diseases (ICD), current procedural terminology (CPT), national drug code (NDC), etc. Such embedding vectors for medical codes are utilized in various use cases, e.g., fraud, waste, and abuse (FWA) detection, next disease prediction, drug-ailment association, etc.

In one example embodiment, medical code embeddings, e.g., ICD, CPT, NDC, etc., are utilized (as a placeholder for medical claims for lack of a better representation of the claim as a whole) during prediction or classification exercises. For example, several works may use top diagnosis and procedure codes, as risk scores, to predict overpayment in claims. Several works may also use embedding vectors for top 2 or 3 diagnosis and procedure codes along with other medical information to predict the same. However, these works simply rely on top diagnosis and procedure codes as there is no way to include all the codes on a claim because the number varies significantly from claim to claim. Nevertheless, for lack of a better representation for the entirety of the medical claim, many solutions opt to use top diagnosis or procedure codes, and indirectly attribute the target variables like payments to them. This approach is flawed because medical claims have shared attributes, e.g., costs, payment amounts, etc., which cannot be associated only to a single diagnosis code or a procedure code on the claim. These attributes belong to the medical claim, as a whole, and should not be divided amongst the medical code embeddings. Furthermore, the comorbidities (usually the secondary, tertiary, and further diagnosis codes) do have a significant impact on the shared attributes associated with the medical claims, and ignoring the comorbidities means losing information. In addition, the same primary diagnosis on different claims may behave differently under different comorbidities. For example, an infectious disease claim with diabetes as a tertiary diagnosis may have a higher risk and may involve more cost, when compared to the same infectious disease claim with arthritis on the tertiary. Hence, using a risk score to represent top diagnosis/procedure codes or simple embedding vectors for the selected top diagnosis/procedure codes may not be able to cover the complete information recorded by the doctors in terms of a complete set of diagnosis/procedure codes. Further, static risk scores or embedding vectors tend to ignore the interactions between diagnosis and procedure codes.

Since medical codes may be encoded as vectors in the form of embedding vectors, it may be argued that all the corresponding embedding vectors for all the codes may be simply stacked or appended one after the other to represent a claim. The issue with this representation is that the claims may be restricted to a pre-defined number of medical codes. Most of the deep learning algorithms may need a fixed shaped input to start with, and as different claims have different claim lines and hence different numbers of diagnosis and procedure codes, the shape and size of the input may need to be defined beforehand. Further, if all the embedding vectors (for the medical codes generated using algorithms like Glove) are for example stacked to form a matrix, restricting it to a specific size may be a problem and one may not be able to specify interactions among the medical codes. In another example, if all the embedding vectors are appended, i.e., embedding vectors for the codes in the claims are arranged one after the other to form a long row (a long vector), then it may also miss the interaction amongst the codes along with the constraint of a predefined size. Hence, there is a need for a method that represents the claim as a unit and retains all the information with respect to the ingredients, e.g., diagnoses and procedures, and the interaction dynamics, e.g., interactions amongst the diagnoses and procedures along with other medical information.

Therefore, the embodiments of the present disclosure are directed to solving, mitigating, or rectifying the above-mentioned issues. For example, certain embodiments may process claim data to create one or more two-dimensional (2D) matrices arranged one after the other like frames in a video. The one or more 2D matrices may represent different combinations of interacting diagnosis and procedure codes of a medical claim and a sequence of these 2D matrices may represent an entirety (or near entirety) of the codes associated with the medical claim. The claim can then be processed similarly to a video file (e.g., a sequence of frames). Certain embodiments may then use a sequence of 2D matrices (representing interacting medical codes) along with other claims to perform various actions, such as fraud detection, medical claim approval/denial, and/or the like. In this way, certain embodiments may improve medical claim processing by evaluating more than just a subset of the claim data associated with a medical claim and/or evaluating interactions between various diagnoses and procedures associated with a patient.

Certain non-limiting embodiments are described below with reference to block diagrams and operational illustrations of methods, processes, devices, and apparatus. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

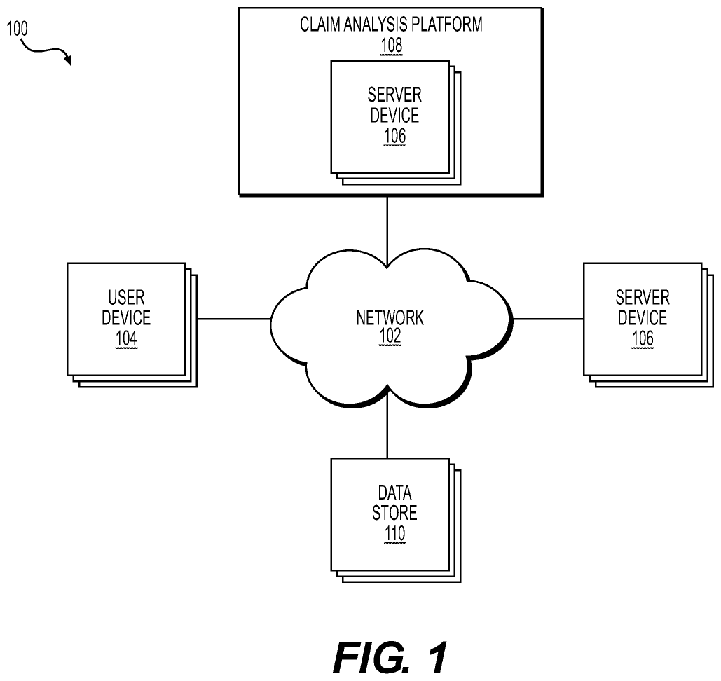

Referring now to the appended drawings, FIG. 1 depicts a block diagram of an exemplary system 100 for processing medical claims to determine embedding vectors for predictive analytics and fraud detection, according to one or more embodiments. As illustrated in FIG. 1, the system 100 may include network 102, one or more user devices 104, one or more server devices 106, a claim analysis platform 108, which may include one or more of the server devices 106, and one or more data stores 110.

In one embodiment, various elements of system 100 may communicate with each other through network 102. Network 102 may support a variety of different communication protocols and communication techniques. In one embodiment, network 102 allows claim analysis platform 108 to communicate with user device 104, server device 106, and data store 110. The network 102 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular communication network and may employ various technologies including 5G (5th Generation), 4G, 3G, 2G, Long Term Evolution (LTE), wireless fidelity (Wi-Fi), Bluetooth®, Internet Protocol (IP) data casting, satellite, mobile ad-hoc network (MANET), vehicle controller area network (CAN bus), and the like, or any combination thereof.

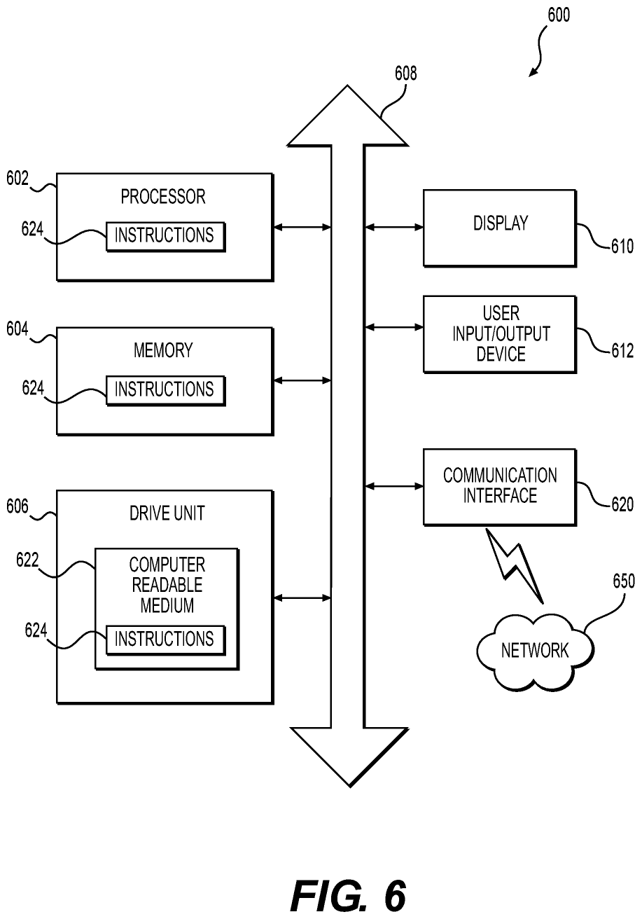

In one embodiment, user device 104 may include, but is not restricted to, any type of a mobile terminal, wireless terminal, fixed terminal, or portable terminal. Examples of user device 104, may include, but are not restricted to, a mobile handset, a wireless communication device, a station, a unit, a device, a multimedia computer, a multimedia tablet, an Internet node, a communicator, a desktop computer, a laptop computer, a notebook computer, a netbook computer, a tablet computer, a Personal Communication System (PCS) device, a personal navigation device, a Personal Digital Assistant (PDA), a digital camera/camcorder, an infotainment system, a dashboard computer, a television device, or any combination thereof, including the accessories and peripherals of these devices, or any combination thereof. In addition, user device 104 may facilitate various input means for receiving and generating information, including, but not restricted to, a touch screen capability, a keyboard, and keypad data entry, a voice-based input mechanism, and the like, consistent with the computing device shown in FIG. 6. Any known and future implementations of user device 104 may also be applicable.

In one embodiment, user device 104 may include various applications such as, but not restricted to, content provisioning applications, networking applications, multimedia applications, media player applications, camera/imaging applications, software applications, and the like. In one embodiment, one of the applications at user device 104 may act as a client for claim analysis platform 108 and may perform one or more functions associated with the functions of claim analysis platform 108 by interacting with claim analysis platform 108 over network 102.

In one embodiment, user device 104 may include various applications such as, but not restricted to, a network detection sensor for detecting wireless signals or receivers for different short-range communications (e.g., Bluetooth, Wi-Fi, Li-Fi, near field communication (NFC), etc.), a camera/imaging sensor for gathering image data, an audio recorder for gathering audio data, and the like.

The server device 106 may include a service point which provides, e.g., processing, database, and communication facilities. By way of example, and not limitation, the term “server device” can refer to a single, physical processor with associated communications and data storage and database facilities, or it can refer to a networked or clustered complex of processors, such as an elastic computer cluster, and associated network and storage devices, as well as operating software and one or more database systems and application software that support the services provided by the server. The server device 106, for example, can be a cloud-based server, a cloud-computing platform, or a virtual machine. Server devices 106 can vary widely in configuration or capabilities, but generally a server can include one or more central processing units and memory. A server device 106 can also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

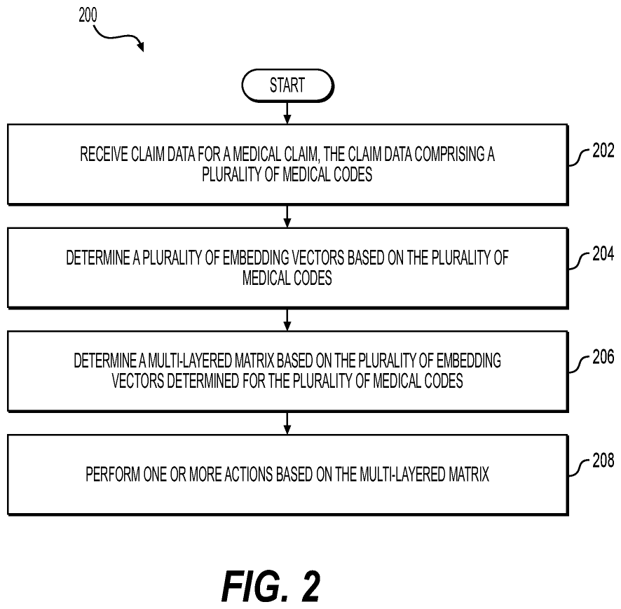

In one embodiment, claim analysis platform 108 may be a platform with multiple interconnected components. Claim analysis platform 108 may include one or more servers, intelligent networking devices, computing devices, components, and corresponding software for processing medical claims to determine embedding vectors for predictive analytics and fraud detection. In one embodiment, claim analysis platform 108 may include a computing platform hosted on one or more server devices 106. The claim analysis platform 108 may provide certain modules, databases, user interfaces, and/or the like for performing certain tasks, such as data processing and/or analysis tasks. For example, claim analysis platform 108 may perform method 200 illustrated in FIG. 2 below. In some embodiments, a user may use user device 104 to access one or more user interfaces associated with claim analysis platform 108 to control operations of claim analysis platform 108.

In one embodiment, claim analysis platform 108 may provide a machine-understandable representation of medical claims as a unit of processing. Claim analysis platform 108 may represent all the ingredient codes of the medical claims, e.g., multiple diagnoses, procedure codes, etc. During the processing of the medical claims, claim analysis platform 108 may ensure the individuality of the medical codes is not lost. The machine-understandable representation of medical claims, by claim analysis platform 108, may differentiate between the respective interactions amongst the medical codes, and may allow for use of established deep learning approaches without any feasibility concerns.

In one embodiment, a machine learning model implemented by claim analysis platform 108 may encompass instructions, data, and/or a model configured to receive input, and apply one or more of a weight, bias, classification, or analysis on the input to generate an output. The output may include, for example, an analysis based on the input, a prediction, suggestion, or recommendation associated with the input, a dynamic action performed by a system, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine earning model may operate on an input linearly, in parallel, via a network (e.g., a neural network), or via any suitable configuration.

In one embodiment, the execution of the machine learning model may include deployment of one or more machine learning techniques, such as k-nearest neighbors, linear regression, logistical regression, random forest, gradient boosted machine (GBM), support-vector machine, deep learning, text classifiers, image recognition classifiers, You Only Look Once (YOLO), a deep neural network, and/or any other suitable machine learning technique that solves problems in the field of Natural Language Processing (NLP). Supervised, semi-supervised, and/or unsupervised training may be employed. For example, supervised learning may include providing training data and labels corresponding to the training data, e.g., as ground truth. Unsupervised approaches may include clustering, classification, principal component analysis (PCA) or the like. K-means clustering or K-Nearest Neighbors may also be used, which may be supervised or unsupervised. Combinations of K-Nearest Neighbors and an unsupervised cluster technique may also be used. Other models for detecting objects in contents/files, such as documents, images, pictures, drawings, and media files may be used as well. Any suitable type of training may be used, e.g., stochastic, gradient boosted, random seeded, recursive, epoch or batch-based, etc. In one embodiment, “natural language processing (NLP)” generally encompasses techniques including, but not limited to, keyword search, finding relationships (e.g., synonyms, hypernyms, hyponyms, and meronyms), extracting information (e.g., keywords, key phrases, search terms), classifying, and determining positive/negative sentiment of documents.

In some embodiments, considering that medical codes may be represented as embedding vectors (using popular algorithms like GLOVE or word-to-vec), also, as argued before the embedding vectors in their standard vector form may not be utilized efficiently to represent the whole claim. Hence, by transforming these embedding vectors (from popular algorithms such as Glove and word-to-vec) into 2D square matrices (while retaining all the information content they possess), they can be arranged as frames in a video and a claim may be analyzed as a video file. This analogy is practical because a typical video file is made up of multiple frames, where we have a background (diagnosis codes and other claim info) and actions like running/jumping, etc. (like procedures) being performed in the foreground.

All embodiments of the present disclosure need to define N×N transformation matrices (also referred to herein as N×N matrix representations or N×N matrices) for each of the N-dimensional embedding vectors (generated for the medical codes using standard methods like Glove or word-to-vec) which satisfy the following two conditions. First, the transformation matrices are rank-1 matrices (i.e., they have only one Eigen vector) and second, they have the corresponding embedding vector as the only Eigen vector.

In all embodiments of the present disclosure, the core concept is substantiated by classic mathematics and linear algebra. A matrix, in linear algebra, may be thought of as a vector transformation. In one example embodiment, matrix, e.g., in linear algebra, may be considered as a transformation, i.e., it may transform a vector in a given space. An example of common transformations may be rotation, sheering, scaling etc. In this example embodiment, a rotation transformation, e.g., 90°, 180°, and 270° counter-clockwise rotations, is provided below:

$$[ \begin{matrix}0 & - 1 \\ 1 & 0\end{matrix} ] , [ \begin{matrix}- 1 & 0 \\ 0 & - 1\end{matrix} ] , [ \begin{matrix}0 & 1 \\ - 1 & 0\end{matrix} ]$$

Eigen vectors of a transformation are vectors that do not transform on the application of the transformation. For example, consider a matrix transformation ‘A’:

$$[ \begin{matrix}3 & 2 & 4 \\ 2 & 0 & 2 \\ 4 & 2 & 3\end{matrix} ]$$

and its Eigen vector ‘v’:

$$[ \begin{matrix}2 \\ 1 \\ 2\end{matrix} ]$$

The transformation of ‘A’ applied to ‘v’ may yield:

$$[ \begin{matrix}3 & 2 & 4 \\ 2 & 0 & 2 \\ 4 & 2 & 3\end{matrix} ] [ \begin{matrix}2 \\ 1 \\ 2\end{matrix} ] = [ \begin{matrix}16 \\ 8 \\ 16\end{matrix} ]$$

Which is:

$$[ \begin{matrix}3 & 2 & 4 \\ 2 & 0 & 2 \\ 4 & 2 & 3\end{matrix} ] [ \begin{matrix}2 \\ 1 \\ 2\end{matrix} ] = [ \begin{matrix}16 \\ 8 \\ 16\end{matrix} ] = 8 * [ \begin{matrix}2 \\ 1 \\ 2\end{matrix} ]$$

This leads to an important property, wherein any transformation applied to its Eigen vectors may give the same vector scaled by a factor:

A*v=λv

Using the above-established theorem of linear algebra, one can solve for a respective transformation matrix for each “embedding vector” (generated for the medical codes using standard methods like Glove or word-to-vec). Such transformation matrices may serve as N×N matrix representations for the respective embedding vector. However, such transformation matrices might have multiple Eigen vectors along with the embedding vector. For Example, the below transformation matrix calculated for a hypothetical “embedding vector” [2, 1, 2], has 2 more Eigen vectors as shown below.

$$[ \begin{matrix}3 & 2 & 4 \\ 2 & 0 & 2 \\ 4 & 2 & 3\end{matrix} ] \to [ \begin{matrix}2 \\ 1 \\ 2\end{matrix} ] , [ \begin{matrix}4 \\ 2 \\ - 5\end{matrix} ] , [ \begin{matrix}1 \\ 2 \\ 0\end{matrix} ]$$

Hence, even though defining and associating a unique transformation matrix for each embedding vector (generated for the medical codes using standard methods like Glove or word-to-vec) is possible, retrieving the embedding vector (Eigen vector) back from the transformation may be infeasible unless the transformation matrix has only one Eigen vector (which is the embedding vector itself). So while there is a requirement of a transformation matrix for each Eigen vector, the transformation matrix should only have one Eigen vector which is the embedding vector (so that the same Eigen vector may be retrieved every time from the transformation matrix). This means the N×N transformation matrices for the respective embedding vectors (generated for the medical codes using standard methods like Glove or word-to-vec) should be rank −1 matrices. In the various embodiments of the current disclosure, the following theorem of Eigen vectors is modified and/or customized to suit the required N×N transformation matrix. If A is a column matrix then AA^{T} is a rank one matrix with only one Eigen vector which is A itself. So for each embedding vector A, claim analysis platform 108 may find the N×N transformation matrix AA^{T}, i.e., 2D matrix representation for each vector.

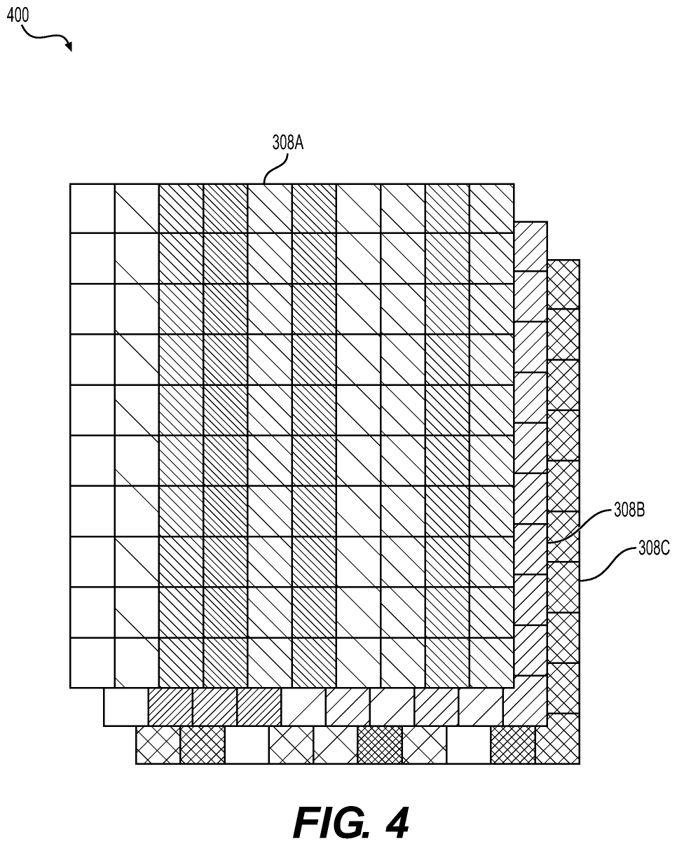

In some embodiments of the current disclosure, embedding vectors denoting medical codes, may be represented as N×N transformation matrices using the Eigen vector theorem. Such an N×N transformation matrix retains all of the information contained in an embedding vector. These matrices can then be arranged on a frame-by-frame basis to form a sequence of frames (N×N transformation matrices) to represent the entirety of the claim along with other claim data. In one embodiment, AA^{T} may only have one Eigen vector, i.e., A. All the columns (or rows based on orientation) may be linearly dependent on each other and the canonical row/column form may reduce it back to A, i.e., each column may be expressed as a multiple of the original vector A. So it retains all the properties of the original row (or column) matrix. The claim may be converted to a three-dimensional (3D) matrix representation by stacking all the codes that need to be analyzed (as depicted in FIG. 4).

In one embodiment, the sequence of N×N transformation matrices may have many layers per requirement (claims having many diagnosis and procedure codes), with each layer representing a respective medical code. These layers may help in preserving individuality, and the convolution operations may learn layer-specific information. However, interactions among the medical codes (diagnosis and procedures) is still not properly reflected during the representation of the claims. For example, infectious disease with diabetes may be at a different level of severity/risk/cost compared to infectious disease with arthritis. However, the claims may have the same first layer in both of these cases, and the model may not be able to differentiate between the two scenarios while building a model with just one diagnosis and procedure code.

In this embodiment, while AA^{T} may have useful properties, however the same properties of rank and Eigen vector may be retained if, instead of AA^{T}, the transpose of another embedding vector, e.g., secondary diagnosis, is utilized. For example, if A₁ is the embedding for the primary diagnosis on a claim and A₂ is the embedding for the secondary diagnosis on the same claim. Then, A₁*A₂^{T} may retain the same properties i.e., (i) it may be an N×N matrix, (ii) it may have only one Eigen vector A₁, and (iii) all the columns of A₁*A₂^{T} may be linearly dependent on A₁. This also solves the problem of interactions between codes, for example, the first layer on the claim may represent the primary diagnosis, and it may now have the primary diagnosis influenced by the secondary diagnosis. The second layer may represent the secondary diagnosis influenced by the tertiary diagnosis, and so on. In contrast with the infectious disease example where both claims had the primary diagnosis as infectious diseases, the different secondary diagnoses in the claims may be represented, and the first layers in the claims will not be the same.

For example, if A is an embedding vector, for example, representing the primary diagnosis then, while A×A^{T} gives us an N×N transformation matrix that can be used to represent A, it may only have one Eigen vector, i.e., A (therefore A can be derived from A×A^{T} anytime) and will retain all the information contained in A many times over as shown. However, when using it in practical use cases, like overpayments, it will only represent a static entity A.

However, if say A₁ is the embedding vector representing the primary diagnosis and A₂ is the embedding vector representing one of the secondary diagnoses, then an N×N transformation matrix may be created by using A₁×A₂^{T}. This N×N matrix will also have only one Eigen vector A₁ and will retain all the information contained in A₁, and A₁ can be derived from it anytime. In addition to all these existing properties, it also captures the interaction between A₁ and A₂. For example, there are two claims, both with A₁ as a primary diagnosis and A₂ and B₂ as their respective secondary diagnoses. So, for the first claim, A₁ will be represented as A₁×A₂^{T} and for the second it will be represented as A₁×B₂^{T}. Now, while both still have the same Eigen vector A₁ and both in their own way will hold all the information of A₁, however, their difference denotes the way A₁ is interacting with A₂ and B₂ respectively. So this also solves the problem of interactions between codes, for example, the first layer on the claim may represent the primary diagnosis influenced by the secondary diagnosis and the second layer can be the secondary diagnosis influenced by tertiary and so on.

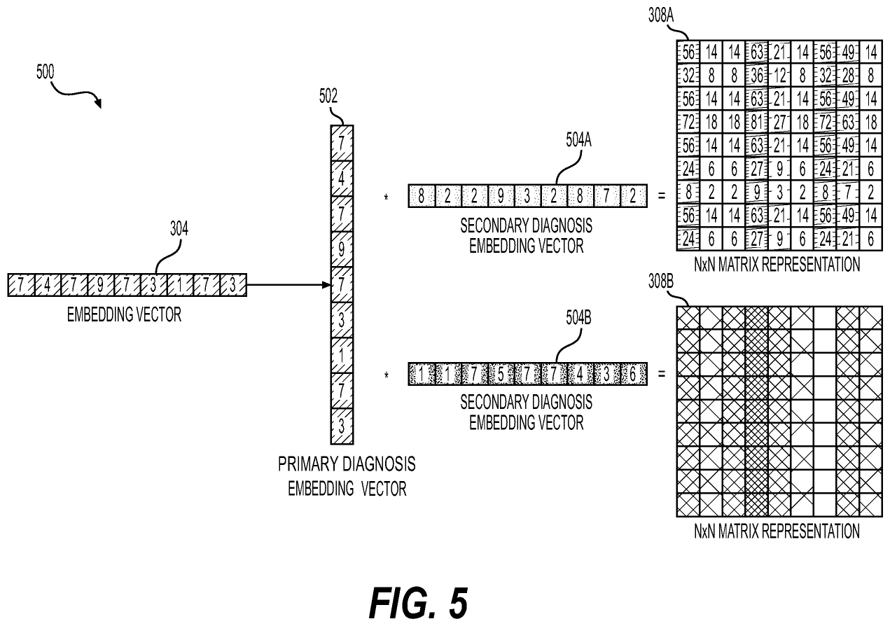

In one embodiment, claim analysis platform 108 may generate an N×N matrix cleared by primary code embedding influenced by secondary code embedding (as illustrated in FIG. 5). For example, the primary diagnosis embedding vector 502 may be an electrical signal, and the secondary code embedding vector 504A, may be a set of amplification voltages being applied to the electrical signal. The result is, the first column in the output matrix is the primary signal (primary embedding) amplified by a factor of 8, and the second column in the output matrix is the primary signal (primary embedding) amplified by a factor of 2, and so on (as depicted in N×N matrix representation 308A). The N×N matrix representation 308A created for the primary diagnosis still represents the primary diagnosis (also its Eigen vector is the primary diagnosis), and its amplifications are dependent on the secondary diagnosis. A different secondary diagnosis will lead to different amplifications, however, the characteristics of the primary diagnosis may still be retained in the matrix. When claim analysis platform 108, via the machine learning model, parse these matrices, it may determine that they represent different amplifications of the same data.

In one embodiment, claim analysis platform 108 may represent the medical codes (with their embedding vectors) on a claim as 2D square matrices (e.g., N×N matrix representations). The 2D square matrices may be an image with channels, e.g., RGB, stacked on one another to form a 3D matrix (e.g., multi-layered matrix representation or multi-layer matrix). The 3D matrix may be the representation of the claim, and each claim represented as a 3D matrix may be treated as an image with multiple channels and may be used as such in various established CNN/RNN architectures, e.g., efficients nets, ResNet, MobileNets, etc.

The data store 110 may include one or more non-volatile memory computing devices that may store data in a data structure, databases, and/or the like. In one example embodiment, data store 110 may be any type of database, such as relational, hierarchical, object-oriented, and/or the like, wherein data are organized in any suitable manner, including as data tables or lookup tables. In one embodiment, data store 110 may store and manage multiple types of information that can provide means for aiding in the content provisioning and sharing process. In an embodiment, data store 110 may include a machine learning based training database with pre-defined mapping defining a relationship between various input parameters and output parameters based on various statistical methods. In an embodiment, the training database may include machine learning algorithms to learn mappings between input parameters related to the user, such as but not limited to medical claims, etc. In an embodiment, the training database may include a dataset that may include data collections that are not subject-specific, i.e., data collections based on population-wide observations, local, regional or super-regional observations, and the like. In an embodiment, the training database may be routinely updated and/or supplemented based on machine learning methods. In one embodiment, data store 110 may include or may be hosted on one or more server devices 106 (not illustrated in FIG. 1). In some embodiments, data store 110 may store claim data, output from claim analysis platform 108, and/or the like.

FIG. 2 is a flowchart of a process for processing medical claims for determining embedding vectors for predictive analytics and fraud detection, according to one or more embodiments. In various embodiments, claim analysis platform 108 may perform one or more portions of method 200 and may be implemented in, for instance, a chip set including a processor and a memory as shown in FIG. 6. Although method 200 is illustrated and described as a sequence of steps, it is contemplated that various embodiments of method 200 may be performed in any order or combination and need not include all of the illustrated steps.

In step 202, claim analysis platform 108 may receive claim data for a medical claim, wherein the claim data includes medical codes such as diagnosis and procedure codes associated with a patient related to the medical claim along with other claim related information, e.g., amounts, charges, and place of service, etc. In one embodiment, claim analysis platform 108 may receive the claim data from user device 104 as user input and/or data store 110. In one example embodiment, claim analysis platform 108 may generate a presentation in a user interface of user device 104 requesting claim data from one or more users. The users of user device 104 may interact with the user interface to provide claim data related to a medical claim. In one embodiment, user device 104 may employ various application programming interfaces (APIs) or other function calls, thus enabling the display of graphics primitives such as icons, menus, buttons, data entry fields, etc. User device 104 may cause interfacing of guidance information with the users to include, at least in part, one or more annotations, audio messages, video messages, or a combination thereof. In another example embodiment, claim analysis platform 108 may automatically collect relevant data associated with the medical claim from data store 110 through various data collection techniques. The data collection techniques may include various software applications, e.g., data mining applications in Extended Meta Language (XML), that automatically search for and return relevant data regarding the medical claim.

In one embodiment, the claim data may include information related to a medical claim. For example, the claim data may include medical codes related to diagnoses and/or procedures associated with a patient, e.g., ICD codes, CPT codes, drug codes, etc. Claim analysis platform 108 may receive other information in association with receiving the claim data. For example, claim analysis platform 108 may receive additional information relating to the patient, e.g., age information, gender information, location information, education level, height information, weight information, and/or the like. The claim analysis platform 108 may also receive data related to one or more similar claims for the patient. In another embodiment, claim analysis platform 108 may receive data related to one or more similar claims for other patients.

In step 204, claim analysis platform 108 may determine an embedding vector for each of the medical codes based on processing the claim data, wherein the embedding vector may represent a diagnosis or a procedure code. Because a medical claim usually contains multiple medical codes (e.g., one or more diagnosis codes and/or one or more procedure codes), for each medical claim, a plurality of embedding vectors may be determined for the corresponding medical codes. In one example embodiment, claim analysis platform 108 may automatically determine embedding vectors upon receiving the claim data from user device 104 and/or data store 110. In another example embodiment, claim analysis platform 108 may determine embedding vectors upon receiving claim data with a command from user device 104 to determine the embedding vectors.

In one embodiment, an embedding vector may include a representation of a categorical variable as a numerical value. For example, embedding vectors according to certain embodiments may represent the various codes included in the claim data as whole numbers. An embedding vector may include a vector that has one dimension of numerical values. For example, an embedding vector according to certain embodiments may have a single column or row of numerical values to represent the various codes of the medical claim. In some embodiments, different embedding vectors may be associated with different combinations of diagnoses and procedures. For example, a first embedding vector may be associated with a first procedure and a first diagnosis and a second embedding vector may be associated with the first procedure and a second diagnosis or a second procedure and the first diagnosis.

In one embodiment, claim analysis platform 108 may determine the embedding vector by mapping the various codes to various values, and storing a representation of those values as a single row or column of values. For example, claim analysis platform 108 may determine a first value for a first code based on a rule indicating that the first code is to be represented as the first value, a second value for a second code based on the rule indicating that the second code is to be represented as the second value, and/or the like.

In another embodiment, claim analysis platform 108 may determine the embedding vectors using one or more machine learning models. For example, claim analysis platform 108 may process the claim data using one or more machine learning models, where the output from one or more machine learning models includes embedding vectors. In one example embodiment, claim analysis platform 108 may input the claim data to one or more machine learning models, the one or more machine learning models may convert the various codes in the claim data to numerical values, and one or more machine learning models may output the embedding vectors. In processing the claim data, one or more machine learning models may extract one or more features from the claim data and may determine the embedding vectors based on the extracted features. For example, one or more machine learning models may extract alphanumeric codes, text descriptions associated with the codes, etc., and may determine the embedding vectors based on the extracted information.

In one embodiment, claim analysis platform 108 may transpose a determined embedding vector from a first dimension to a second dimension. For example, claim analysis platform 108 may transpose a determined embedding vector from a horizontal dimension, e.g., a row of values, to a vertical dimension, e.g., a column of values.

In step 206, claim analysis platform 108 may determine a multi-layered matrix representation (e.g., a multi-layered matrix, a 3D matrix representation, or a 3D matrix) for the medical claim based on the embedding vectors determined for the medical codes, wherein the multi-layered matrix representation is representative of the medical claim. In one embodiment, claim analysis platform 108 may determine the multi-layered matrix representation for the medical claim after determining the embedding vectors, based on receiving a command from user device 104, and/or the like. In another embodiment, claim analysis platform 108 may automatically determine the multi-layered matrix representation for the medical claim after determining the embedding vectors.

In one embodiment, a multi-layered matrix representation for a medical claim may include multiple dimensions of values representing one or more categorical variables. For example, in certain embodiments, a multi-layered matrix representation for a claim may include multiple rows and/or columns of values representing the various codes associated with the medical claim. As a specific example, different multi-layered matrix representations represent different combinations of diagnoses and procedures associated with the respective medical claims. In some embodiments, claim analysis platform 108 may determine the multi-layered matrix representation by multiplying an embedding vector for a medical code by another embedding vector of another medical code on the same claim, thereby generating a 2D matrix (e.g., N×N matrix representation or N×N matrix). For example, claim analysis platform 108 may cross multiply an embedding vector representing a first diagnosis on the claim for a patient by the transpose of a second embedding vector representing a second diagnosis on the same claim for the patient. In certain embodiments, claim analysis platform 108 may cross multiply the multiple embedding vectors, for example, embedding vectors representing procedures with transpose of an embedding vector representing diagnosis. For example, claim analysis platform 108 may multiply a primary code embedding vector by a transpose of a secondary code embedding vector (e.g., represented by A₁*A₂^{T}). In this way, the resulting transformation matrix may be an N×N matrix that has one Eigen vector A₁ where all the columns of the resulting matrix are linearly dependent on A₁ and A₁ can be derived from the matrix and the matrix composition will also define the interaction between A₁ and A₂.

A plurality of 2D matrices stacked on top of another may form a multi-layered matrix representation for a medical claim. For example, determining a multi-layered matrix representation for a medical claim may comprise determining a plurality of N×N matrices based on the embedding vectors associated with the medical codes, wherein each N×N matrix represents a unique combination of one or more diagnosis codes and/or one or more procedure codes. The plurality of N×N matrices determined for the medical claim may together form the multi-layered matrix representation, as explained above.

In one embodiment, claim analysis platform 108 may determine the multi-layered matrix representation, or the plurality of N×N matrices forming the multi-layered matrix representation, using one or more machine learning models. For example, claim analysis platform 108 may input multiple embedding vectors to the one or more machine learning models, the one or more machine learning models may multiply the multiple embedding vectors to determine N×N matrices, and may output the multi-layered matrix representation comprising the N×N matrices.

In step 208, claim analysis platform 108 may perform one or more actions based on the multi-layered matrix representation. In one embodiment, claim analysis platform 108 may perform an action upon determining the multi-layered matrix representation based, at least in part, on a command from user device 104. In another embodiment, claim analysis platform 108 may automatically perform an action upon determining the multi-layered matrix representation. In one embodiment, one or more actions may include detecting overpayment for a medical claim. Claim analysis platform 108 may determine that certain payments and amounts associated with the medical claim cannot be attributed to a particular diagnosis code or procedure code. For example, there may not be a method to divide the amounts/payments amongst the various medical codes of a claim, and primary diagnosis may normally be considered as the defining parameter. Though primary diagnosis is an important factor, not including secondary, tertiary, and further diagnosis codes may result in the loss of useful information that is present on the claim which may have an impact on the amounts/payments. As a specific example, an open wound injury may cost different for patients who have diabetes than for patients who do not have diabetes. In this example, claim analysis platform 108 may use one or more machine learning models to determine whether costs associated with the medical claim, e.g., as determined based on the codes represented by the embedding vectors or multi-layered matrix representation, differ from other similar patients, e.g., based on patients associated with similar combinations of diagnoses and/or procedures, based on patients with similar characteristics, etc., determined by the embedding vectors or multi-layered matrix representations associated with the medical claims of those other patients.

Additionally, or alternatively, and as another example, one or more actions may include detecting fraud associated with a medical claim for a patient. In fraud analysis while performing anomaly detection, algorithms usually rely on the top 2-3 diagnosis codes, such process is not robust. Claim analysis platform 108 may use one or more machine learning models to process the medical claim (represented by the multi-layered matrix representation), as a whole, for the patient and determine whether the medical claim is similar to another medical claim for the patient or for another patient (represented by the corresponding multi-layered matrix representation). Continuing with the previous example, output from one or more machine learning models may include an indication of whether the codes for the medical claim are similar to the codes for the other medical claims based on similar diagnoses and/or characteristics between the patient and the other patient. In this way, certain embodiments may improve fraud detection compared to just using a subset of codes for a medical claim to perform fraud detection.

Additionally, or alternatively, and as another example, one or more actions may include predicting the next medical claims for a patient. In one example embodiment, diseases, e.g., chronic diseases, usually show patterns in terms of the claims they generate, hence claim analysis platform 108 may process the medical claims as a whole (instead of a few diagnosis codes), represented by the corresponding embedding vector or multi-layered matrix representation, for better predictions. Claim analysis platform 108 may trace the patterns within the medical claims, in real-time or near real-time, to predict the expected medical claims for the patient.

Additionally, or alternatively, and as another example, one or more actions may include predicting a value associated with a medical claim. In one example embodiment, claim analysis platform 108 may use one or more machine learning models to process one or more multi-layered matrix representations associated with medical claims for a patient over time and may predict the cost of the next medical claim based on procedures that the patient has received in the past and costs of those procedures, based on the costs of medical claims associated with other patients that have similar diagnoses, that have received similar procedures, that have similar characteristics as the patient, and/or the like.

Additionally, or alternatively, and as another example, one or more actions may include determining whether the medical claim is similar to one or more other medical claims and approving the medical claim or denying the medical claim. For example, claim analysis platform 108 may use one or more machine learning models to determine whether the medical claim, represented by a corresponding multi-layered matrix representation, is associated with similar procedures for similar diagnoses as the one or more other medical claims, represented by corresponding multi-layered matrix representations. If claim analysis platform 108 determines the medical claim is similar to one or more other medical claims based on output from one or more machine learning models (e.g., a score indicating a degree of similarity of the medical claim to the one or more other medical claims), claim analysis platform 108 may send a message to a server device 106 to approve the medical claim. If claim analysis platform 108 determines the medical claim is not similar to one or more other medical claims based on output from one or more machine learning models, claim analysis platform 108 may send a message to a server device 106 to deny the medical claim, flag it for overpayment, mark it for appeal rework, or determine if it is a fraudulent claim, etc.

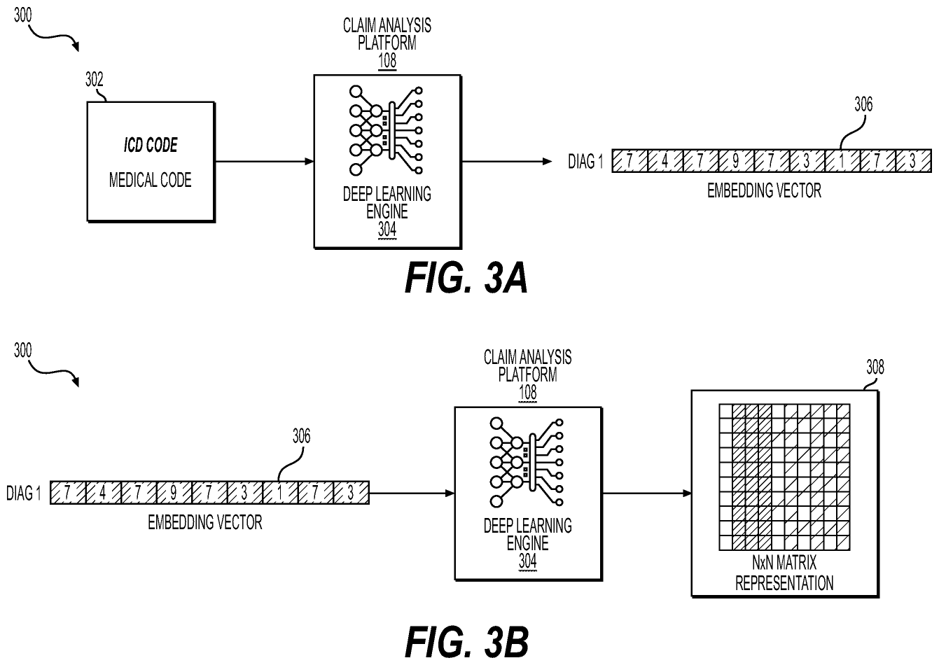

FIGS. 3A and 3B depict an example 300 for processing medical claims to determine embedding vectors, according to one or more embodiments. As illustrated in FIGS. 3A, example 300 may include claim data 302, which may include one or more medical codes. As explained above, each medical code may include or represent one or more diagnosis codes, one or more procedure codes, or a combination thereof. Example 300 may further include a claim analysis platform 108 that stores a deep learning engine 304, which may implement one or more machine learning models. In this example embodiment, claim analysis platform 108 may receive claim data 302, in a manner similar to that described above at step 202 of FIG. 2. The claim analysis platform 108 may process claim data 302 using the deep learning engine 304 and may output embedding vectors 306 for the corresponding medical codes in the claim data, in a manner similar to that described above in connection with step 204 of FIG. 2. In some embodiments, claim analysis platform 108 may store the embedding vector 306 determined for each medical code in data store 110 (not shown in FIG. 3A). As illustrated, the embedding vector 306 may include various numerical values arranged in a first dimension, e.g., a horizontal dimension. As previously discussed, the embedding vector may represent various diagnosis and/or procedure codes in the claim data.

Turning to FIG. 3B, claim analysis platform 108 may input the embedding vector 306 into the deep learning engine 304 for processing in a manner similar to that described above in connection with step 206 of FIG. 2. The claim analysis platform 108 may output a N×N matrix representation 308 for each embedding vector that is input to the claim analysis platform 108 (or deep learning engine 304 therein). The claim analysis platform 108 may then perform one or more actions using the multi-layered matrix representation (or 3D matrix representation), which includes layers of N×N matrix representations output by the deep learning engine 304, similar to that described in step 208 of FIG. 2. Although FIG. 3B illustrates that the N×N matrix representation is output using a deep learning engine 304, the N×N matrix representation may be determined simply using an algorithm or a logic configured to perform computations based on pre-defined formulas or steps. In one embodiment, embedding vectors (each embedding vector representing a diagnosis, a procedure, or a combination thereof on a claim) are converted to corresponding N×N matrix representations (each of which essentially represents the respective embedding vector) using novel mathematical calculations and not a deep learning engine. In another embodiment, two embedding vectors (each embedding vector representing a diagnosis, a procedure, or a combination thereof on a claim) are converted to N×N matrix representations (each of which essentially represents the first embedding vector) using novel mathematical calculations and not a deep learning engine.

In one example embodiment, the N×N matrix may represent a single medical code, and convolution may begin by understanding a layer of numbers that may collectively denote one medical code. Claim analysis platform 108 may stack the codes, e.g., several N×N 2D-Matrices, so that they work as layers in a three-dimensional (3D) structure, e.g., a 3D Matrix or the multi-layered matrix representation, thereby maintaining their individuality as well as a co-occurrence. This may be run through known convolution architectures for training deep learning engine 304. This format is more feasible than having the embedding vectors themselves appended to form a very long vector for the claim. For example, “N-dimensional” embedding vector may be converted to an “N×N matrix,” and the whole claim may comprise of a few such matrices arranged as layers of a 3D Matrix. Each layer in the 3D-Matrix may represent a medical code, e.g., procedure, primary/secondary/tertiary diagnosis, etc.

FIG. 4 depicts an example 400 of a multi-layered matrix representation (or 3D matrix representation), according to one or more embodiments. In order to represent a medical claim that includes multiple diagnoses, certain embodiments may stack one after the other, several N×N matrix representations for the medical codes on a claim. For example, and as illustrated at 400, claim analysis platform 108 may associate the N×N matrix representations of medical codes in a claim 308A, 308B, and 308C with each other in order to represent a medical claim. For example, the N×N matrix representation 308A may represent a procedure delivered to a patient interacted with the primary diagnosis, the N×N matrix representation 308B may represent a primary diagnosis interacted with secondary diagnosis made for the patient, and the N×N matrix representation 308C may represent a secondary diagnosis interacted with the tertiary diagnosis made for the patient. One or more additional N×N matrix representations of medical codes may be used to represent the medical claim, which may represent a tertiary diagnosis, a quaternary diagnosis, and so forth.

As described elsewhere herein, each of the N×N matrix representations of medical codes may be generated by using a different matrix multiplication for each of the embedding vectors for the medical codes in a claim. For example, claim analysis platform 108 may determine the N×N matrix representation 308A by multiplying the embedding vector of the first medical code on the claim by a transpose of embedding vector of the second medical code (e.g., V1*V2^{T}), may determine the N×N matrix representation 308B by multiplying the embedding vector of the second medical code on the claim by a transpose of embedding vector of the third medical code (e.g., V2*V3^{T}), and the N×N matrix representation 308C by multiplying the embedding vector of the third medical code on the claim by a transpose of embedding vector of the forth medical code (e.g., V3*V4^{T}). Alternatively, and as another example, claim analysis platform 108 may determine the N×N matrix representation 308A by multiplying the embedding vector of the first medical code on the claim by a transpose of embedding vector of the second medical code (e.g., V1*V2^{T}), may determine the N×N matrix representation 308B by multiplying the embedding vector of the first medical code on the claim by a transpose of embedding vector of the third medical code (e.g., V1*V3^{T}), and the N×N matrix representation 308C by multiplying the embedding vector of the first medical code on the claim by a transpose of embedding vector of the forth medical code (e.g., V1*V4^{T}).

FIG. 5 depicts an example 500 of determining one or more N×N matrix representations, according to one or more embodiments. For example, FIG. 5 illustrates example operations of claim analysis platform 108 related to determining one or more N×N matrix representations for medical codes. As illustrated, claim analysis platform 108 may transpose an embedding vector for a medical code to form a transposed single-dimension vector 502. For example, claim analysis platform 108 may transpose the embedding vector 306 for primary diagnosis to form a column vector 502. The transposed embedding vector 502 may represent a primary diagnosis for a patient.

The claim analysis platform 108 may multiply the transposed embedding vector 502 by an embedding vector 504A, which may represent a secondary diagnosis for the patient. Multiplying the embedding vector 502 by the embedding vector 504A may result in one N×N matrix representation 308A which essentially can represent embedding vector 502 in terms of information content. In this way, the N×N matrix representation 308A may represent an interaction between the primary diagnosis and the secondary diagnosis.

For another claim with the same primary diagnosis and a different secondary diagnosis, the claim analysis platform 108 may multiply the transposed embedding vector 502 by an embedding vector 504B, which may represent another secondary diagnosis for the patient. Multiplying the embedding vector 502 by the embedding vector 504B may result in another N×N matrix representation 308B. In this way, the N×N matrix representation 308B may represent an interaction between the primary diagnosis and the other secondary diagnosis for this claim. Essentially both N×N matrix representations 308A and 308B may represent the same primary diagnosis but since the secondary diagnosis is different, the N×N matrix representations become different and differentiate the interaction between medical codes.

The claim analysis platform 108 may associate the N×N matrix representations 308A, 308B to represent medical claims, in a manner similar to that illustrated in FIG. 4. The claim analysis platform 108 may then perform one or more actions using the N×N matrix representations 308A, 308B, (e.g., or using corresponding multi-layered matrix representation(s)) in a manner similar to that described at step 208 of FIG. 2.

FIG. 6 illustrates an implementation of a general computer system that may execute techniques presented herein. The computer system 600 can include a set of instructions that can be executed to cause the computer system 600 to perform any one or more of the methods or computer based functions disclosed herein. The computer system 600 may operate as a standalone device or may be connected, e.g., using a network, to other computer systems or peripheral devices.

In a networked deployment, the computer system 600 may operate in the capacity of a server or as a client user computer in a server-client user network environment, or as a peer computer system in a peer-to-peer (or distributed) network environment. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 600 can be implemented using electronic devices that provide voice, video, or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (CPU), a graphics processing unit (GPU), or both. The processor 602 may be a component in a variety of systems. For example, the processor 602 may be part of a standard personal computer or a workstation. The processor 602 may be one or more general processors, digital signal processors, application specific integrated circuits, field programmable gate arrays, servers, networks, digital circuits, analog circuits, combinations thereof, or other now known or later developed devices for analyzing and processing data. The processor 602 may implement a software program, such as code generated manually (i.e., programmed).

The computer system 600 may include a memory 604 that can communicate via a bus 608. The memory 604 may be a main memory, a static memory, or a dynamic memory. The memory 604 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 604 includes a cache or random-access memory for the processor 602. In alternative implementations, the memory 604 is separate from the processor 602, such as a cache memory of a processor, the system memory, or other memory. The memory 604 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 604 is operable to store instructions executable by the processor 602. The functions, acts or tasks illustrated in the figures or described herein may be performed by the programmed processor 602 executing the instructions stored in the memory 604. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 600 may further include a display unit 610, such as a liquid crystal display (LCD), an organic light emitting diode (OLED), a flat panel display, a solid-state display, a cathode ray tube (CRT), a projector, a printer or other now known or later developed display device for outputting determined information. The display unit 610 may act as an interface for the user to see the functioning of the processor 602, or specifically as an interface with the software stored in the memory 604 or in the drive unit 606.

Additionally or alternatively, the computer system 600 may include an input device 612 configured to allow a user to interact with any of the components of system 600. The input device 612 may be a number pad, a keyboard, or a cursor control device, such as a mouse, or a joystick, touch screen display, remote control, or any other device operative to interact with the computer system 600.

The computer system 600 may also or alternatively include a disk or optical drive unit 606. The disk drive unit 606 may include a computer-readable medium 622 in which one or more sets of instructions 624, e.g. software, can be embedded. Further, the instructions 624 may embody one or more of the methods or logic as described herein. The instructions 624 may reside completely or partially within the memory 604 and/or within the processor 602 during execution by the computer system 600. The memory 604 and the processor 602 also may include computer-readable media as discussed above.

In some systems, a computer-readable medium 622 includes instructions 624 or receives and executes instructions 624 responsive to a propagated signal so that a device connected to a network 650 can communicate voice, video, audio, images, or any other data over the network 650. Further, the instructions 624 may be transmitted or received over the network 650 via a communication port or interface 620, and/or using a bus 608. The communication port or interface 620 may be a part of the processor 602 or may be a separate component. The communication port or interface 620 may be created in software or may be a physical connection in hardware. The communication port or interface 620 may be configured to connect with a network 650, external media, the display unit 610, or any other components in system 600, or combinations thereof. The connection with the network 650 may be a physical connection, such as a wired Ethernet connection or may be established wirelessly as discussed below. Likewise, the additional connections with other components of the system 600 may be physical connections or may be established wirelessly. The network 650 may alternatively be directly connected to the bus 608.

While the computer-readable medium 622 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 622 may be non-transitory, and may be tangible.

The computer-readable medium 622 can include a solid-state memory such as a memory card or other package that houses one or more non-volatile read-only memories. The computer-readable medium 622 can be a random-access memory or other volatile re-writable memory. Additionally or alternatively, the computer-readable medium 622 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 600 may be connected to one or more networks 650. The network 650 may define one or more networks including wired or wireless networks. The wireless network may be a cellular telephone network, an 802.11, 802.16, 802.20, or WiMax network. Further, such networks may include a public network, such as the Internet, a private network, such as an intranet, or combinations thereof, and may utilize a variety of networking protocols now available or later developed including, but not limited to TCP/IP based networking protocols. The network 650 may include wide area networks (WAN), such as the Internet, local area networks (LAN), campus area networks, metropolitan area networks, a direct connection such as through a Universal Serial Bus (USB) port, or any other networks that may allow for data communication. The network 650 may be configured to couple one computing device to another computing device to enable communication of data between the devices. The network 650 may generally be enabled to employ any form of machine-readable media for communicating information from one device to another. The network 650 may include communication methods by which information may travel between computing devices. The network 650 may be divided into sub-networks. The sub-networks may allow access to all of the other components connected thereto or the sub-networks may restrict access between the components. The network 650 may be regarded as a public or private network connection and may include, for example, a virtual private network or an encryption or other security mechanism employed over the public Internet, or the like.

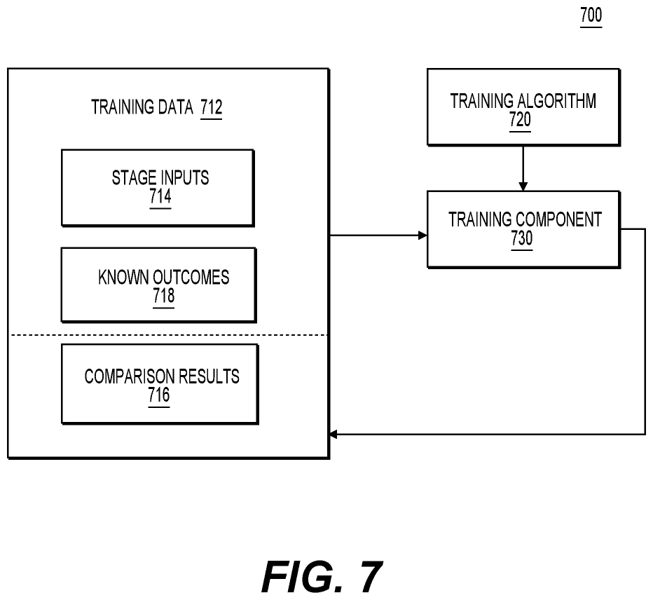

One or more implementations disclosed herein include and/or may be implemented using a machine learning model. For example, claims analysis platform 108 and/or deep learning engine 304 may be implemented using a machine learning model and/or may be used to train the machine learning model. A given machine learning model may be trained using the data flow 700 of FIG. 7. Training data 712 may include one or more of stage inputs 714 and known outcomes 718 related to the machine learning model to be trained. The stage inputs 714 may be from any applicable source including text, visual representations, data, values, comparisons, stage outputs (e.g., one or more outputs from a step from FIG. 3). The known outcomes 718 may be included for the machine learning models generated based on supervised or semi-supervised training. An unsupervised machine learning model may not be trained using known outcomes 718. Known outcomes 718 may include known or desired outputs for future inputs similar to or in the same category as stage inputs 714 that do not have corresponding known outputs.

The training data 712 and a training algorithm 720 (e.g., one or more of the modules implemented using the machine learning model and/or may be used to train the machine learning model) may be provided to a training component 730 that may apply the training data 712 to the training algorithm 720 to generate the machine learning model. According to an implementation, the training component 730 may be provided comparison results 716 that compare a previous output of the corresponding machine learning model to apply the previous result to re-train the machine learning model. The comparison results 716 may be used by the training component 730 to update the corresponding machine learning model. The training algorithm 720 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like.

The machine learning model used herein may be trained and/or used by adjusting one or more weights and/or one or more layers of the machine learning model. For example, during training, a given weight may be adjusted (e.g., increased, decreased, removed) based on training data or input data. Similarly, a layer may be updated, added, or removed based on training data/and or input data. The resulting outputs may be adjusted based on the adjusted weights and/or layers.

In general, any process or operation discussed in this disclosure that is understood to be computer-implementable, such as the process illustrated in FIG. 3 may be performed by one or more processors of a computer system as described herein. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosed embodiments are not limited to any particular implementation or programming technique and that the disclosed embodiments may be implemented using any appropriate techniques for implementing the functionality described herein. The disclosed embodiments are not limited to any particular programming language or operating system.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for generating machine-understandable representations of medical claims, the method comprising:
receiving claim data for a medical claim, the claim data comprising a plurality of medical codes;
determining a plurality of embedding vectors based on the plurality of medical codes, each embedding vector determined based on a corresponding medical code;
determining a multi-layered matrix based on the plurality of embedding vectors determined for the plurality of medical codes, wherein the multi-layered matrix is representative of the medical claim; and
performing one or more actions based on the multi-layered matrix.

2. The computer-implemented method of claim 1, wherein determining the multi-layered matrix based on the plurality of embedding vectors determined for the plurality of medical codes comprises:
determining a plurality of N×N matrices based on the plurality of embedding vectors, wherein each N×N matrix represents a unique combination of one or more diagnoses and/or one or more procedures; and
determining the multi-layered matrix representation based on the plurality of N×N matrices.

3. The computer-implemented method of claim 2, wherein determining the plurality of N×N matrices based on the plurality of embedding vectors comprises:
transposing an embedding vector from a first dimension to a second dimension; and
multiplying the embedding vector in the second dimension by the embedding vector in the first dimension or another embedding vector in the first dimension.

4. The computer-implemented method of claim 1, wherein determining the plurality of embedding vectors based on the plurality of medical codes comprises:
processing the claim data using one or more machine learning models, wherein an output from the one or more machine learning models comprises the plurality of embedding vectors.

5. The computer-implemented method of claim 4, wherein determining the multi-layered matrix based on the plurality of embedding vectors determined for the plurality of medical codes comprises:
converting the plurality of embedding vectors for the plurality of medical codes, derived using the one or more machine learning models, into a plurality of N×N matrices, wherein each N×N matrix is determined based on one or two embedding vectors; and
determining the multi-layered matrix based on the plurality of N×N matrices.

6. The computer-implemented method of claim 1, wherein the multi-layered matrix representation comprises a plurality of N×N matrices determined based on the plurality of embedding vectors, wherein each N×N matrix is determined based on one or two embedding vectors, and wherein the multi-layered matrix is three dimensional (3D).

7. The computer-implemented method of claim 1, wherein performing the one or more actions based on the multi-layered matrix comprises:
predicting a value associated with another medical claim based on the multi-layered matrix.

8. The computer-implemented method of claim 1, wherein performing the one or more actions based on the multi-layered matrix comprises:
detecting fraud associated with another medical claim based on the multi-layered matrix.

9. The computer-implemented method of claim 1, wherein performing the one or more actions based on the multi-layered matrix comprises:
determining whether another medical claim is similar to the medical claim based on the multi-layered matrix representation; and
approving the another medical claim based on a similarity of the another medical claim to the medical claim, or
denying the another medical claim based on a similarity of the another medical claim to the medical claim.

10. The computer-implemented method of claim 1, wherein the multi-layered matrix is a representation of the medical claim comprising a plurality of frames of fixed size matrices.

11. A system for generating machine-understandable representations of medical claims, the system comprising:
a memory having processor-readable instructions stored therein; and
a processor configured to access the memory and execute the processor-readable instructions to perform operations comprising:
receiving claim data for a medical claim, the claim data comprising a plurality of medical codes;
determining a plurality of embedding vectors based on the plurality of medical codes, each embedding vector determined based on a corresponding medical code;
determining a multi-layered matrix based on the plurality of embedding vectors determined for the plurality of medical codes, wherein the multi-layered matrix is representative of the medical claim; and
performing one or more actions based on the multi-layered matrix.

12. The system of claim 11, wherein determining the multi-layered matrix based on the plurality of embedding vectors determined for the plurality of medical codes comprises:
determining a plurality of N×N matrices based on the plurality of embedding vectors, wherein each N×N matrix represents a unique combination of one or more diagnoses and/or one or more procedures; and
determining the multi-layered matrix representation based on the plurality of N×N matrices.

13. The system of claim 12, wherein determining the plurality of N×N matrices based on the plurality of embedding vectors comprises:
transposing an embedding vector from a first dimension to a second dimension; and
multiplying the embedding vector in the second dimension by the embedding vector in the first dimension or another embedding vector in the first dimension.

14. The system of claim 11, wherein determining the plurality of embedding vectors based on the plurality of medical codes comprises:
processing the claim data using one or more machine learning models, wherein an output from the one or more machine learning models comprises the plurality of embedding vectors.

15. The system of claim 14, wherein determining the multi-layered matrix based on the plurality of embedding vectors determined for the plurality of medical codes comprises:
converting the plurality of embedding vectors for the plurality of medical codes, derived using the one or more machine learning models, into a plurality of N×N matrices, wherein each N×N matrix is determined based on one or two embedding vectors; and
determining the multi-layered matrix based on the plurality of N×N matrices.

16. The system of claim 11, wherein the multi-layered matrix representation comprises a plurality of N×N matrices determined based on the plurality of embedding vectors, wherein each N×N matrix is determined based on one or two embedding vectors, and wherein the multi-layered matrix is three dimensional (3D).

17. The system of claim 11, wherein performing the one or more actions based on the multi-layered matrix comprises:
predicting a value associated with another medical claim based on the multi-layered matrix.

18. A non-transitory computer-readable medium storing a set of instructions that, when executed by a processor, perform operations for generating machine-understandable representations of medical claims, the operations comprising:
receiving claim data for a medical claim, the claim data comprising a plurality of medical codes;
determining a plurality of embedding vectors based on the plurality of medical codes, each embedding vector determined based on a corresponding medical code;
determining a multi-layered matrix based on the plurality of embedding vectors determined for the plurality of medical codes, wherein the multi-layered matrix is representative of the medical claim; and
performing one or more actions based on the multi-layered matrix.

19. The non-transitory computer-readable medium of claim 18, wherein determining the multi-layered matrix based on the plurality of embedding vectors determined for the plurality of medical codes comprises:
determining a plurality of N×N matrices based on the plurality of embedding vectors, wherein each N×N matrix represents a unique combination of one or more diagnoses and/or one or more procedures; and
determining the multi-layered matrix representation based on the plurality of N×N matrices.

20. The non-transitory computer-readable medium of claim 19, wherein determining the plurality of N×N matrices based on the plurality of embedding vectors comprises:
transposing an embedding vector from a first dimension to a second dimension; and
multiplying the embedding vector in the second dimension by the embedding vector in the first dimension or another embedding vector in the first dimension.
